(19) United States
(12) Patent Application Publication
(10) Pub. No.: US 2023/0202135 A1
(43) Pub. Date: Jun. 29, 2023

(54) METHOD OF FORMING BIODEGRAD ABFE NONWOVEN FABRIC, NONWOVEN FABRIC OBTAINED BY THIS METHOD, AND SYSTEM OF DEVICES FOR CARRYING OUT THIS METHOD

(71) Applicants: Gabriel KERMICHE, Warszawa (PL); Artur GALWIACZEK, Warszawa (PL)

(72) Inventors: Gabriel KERMICHE, Warszawa (PL); Artur GALWIACZEK, Warszawa (PL)

(21) Appl. No.: 17/996,825

(22) PCT Filed: Apr. 21, 2021
(86) PCT No.: PCT/IB2021/053296

§ 371 Date: Oct. 21, 2022

(30) Foreign Application Priority Data
Apr. 21, 2020 (PL) P.433609

(51) Int. Cl. B32B 5/26; D04H 1/4258; D04H 1/425; D04H 1/435; D04H 1/4374; D04H 1/498; D04H 1/492; B32B 5/02; D04H 1/541; D04H 1/559

(52) U.S. Cl. CPC B32B 5/266; D04H 1/4258; D04H 1/425; D04H 1/435; D04H 1/4374; D04H 1/498; D04H 1/492; B32B 5/022; D04H 1/5412; D04H 1/5418; D04H 1/559; D10B 2401/12; B32B 2262/062; D10B 2201/01; B32B 2262/04; B32B 2307/716; D10B 2509/00; B32B 2250/02; B32B 2307/718; B32B 2262/0276; B32B 2262/124; B32B 2250/20; B32B 2432/00

(57) ABSTRACT

The invention relates to a method of forming a biodegradable nonwoven fabric, the nonwoven fabric obtained by this method, and a system of devices for carrying out this method, to be used for the manufacture of cellulosic articles for clean-up work and sanitary products, and medical uses.

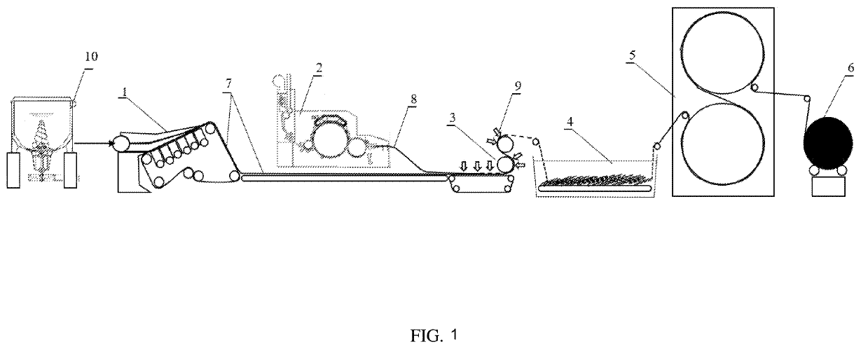

### FIELD OF THE INVENTION

The invention relates to a method of forming a biodegradable nonwoven fabric, the nonwoven fabric obtained by this method, and a system of devices for carrying out this method, to be used for the manufacture of cellulosic articles for clean-up work and sanitary products, and medical uses.

### BACKGROUND ART

At present, there is no biodegradable nonwoven fabric, which would be sufficiently strong and resistant against pilling, to be used in the sanitary article industry and for household uses, e.g. for clean-up work, at the same time being manufactured by a process, which could be deemed remunerative (cost-effective).

Due to a relatively low cost of cellulose pulp fibers, their good absorbing capacity and excellent dirt gathering ability, many kinds of composite nonwoven fabrics containing cellulose pulp fibers in their composition are used at present. Typically, nonwoven fabrics are made as a combination of pulp fibers with thermoplastic fibers made from petroleum-derived substances, optionally with other additives responsible for bonding short pulp fibers, which determine strength of a nonwoven fabric material.

Non-biodegradable petroleum-derived polymeric components render the nonwoven fabric obtained in the known process non-compostable and non-biodegradable, and moreover difficult and expensive to utilize after its use.

The problem of nonwoven fabrics made from cellulose pulp appears in the patent literature. Worthy of notice is European patent no. EP0492554B1, which describes a nonwoven fabric material, wherein cellulose pulp constitutes more than 70% of a total weight of the nonwoven fabric. The nonwoven fabric is manufactured by applying pulp fibers on a thermally welded layer made from thermoplastic filaments forming so-called a spunbond layer, followed by water needling to bond both layers. According to the above-referenced description, the obtained nonwoven fabric employs up to 30% of petroleum-derived polymers, which are non-biodegradable.

Next, from Chinese patent no. CN101619520B a process is known, wherein an aerodynamically formed layer of cellulose pulp is applied onto a spunbond layer made from polylactide (PLA) filaments, and on the top of both layers a fiber fleece formed in a carding machine is laid. The three components are then bonded by the known water needling process. The nonwoven fabric obtained therefrom may be biodegradable, when two conditions are met—when a carded product layer is made from biodegradable fibers, and when a final material is subjected to composting in an industrial composting plant, where sufficiently high temperature and humidity is maintained, to allow degradation of a spunbond composite made of PLA.

On the other hand, from the U.S. Pat. No. 7,062,824B2 a process for the manufacture of a composite nonwoven fabric rich in cellulose pulp is known, wherein on a carded fiber layer pre-compacted on a calender, a layer of an aerodynamically formed cellulose pulp is applied, followed by bonding of both layers together by water needling to obtain a structure of a resistant nonwoven fabric. Also in this case, susceptibility of the obtained nonwoven fabric to biodegradation depends on a kind of fibers used in forming of a carded layer, i.e. susceptibility thereof to biodegradation.

Yet another processes for the manufacture of composite nonwoven fabric materials containing cellulose pulp are generally known, such as SPC—Spunbond+Pulp+Carded, SPS—Spunbond+Pulp+Spunbond, Arvell—manufactured according a scheme Meltblown+Pulp+Meltblown, wherein at least one of the layers, made from a non-biodegradable petroleum-derived polymer, is initially bonded before a pulp fiber layer is applied.

A process is generally known, wherein fibers of pneumatically pumped pulp are mixed with molten micro-fibers made of thermoplastic polymers, and such a mixture is formed into a layer. During the process of mixing and layer-forming the polymer fibers are warm and tacky enough to bond durably the pulp fibers. In such a process, a material is formed which is marketed under the brand name Coform.

In common use is also another process of bonding pulp fibers with thermally activated bonding components. In such a process, the bonding component is heated and melted after a fiber layer is formed in a special through-air dryer and calendered by hot rollers. Moreover, to provide surfaces of the obtained material with higher softness and slightly reduce release of fibers and dust from a nonwoven fabric surface, a finish on both surfaces of a thin latex layer of about 1-2 g/m² is applied. Such a material is manufactured by several producers in the world and sold under the name “airlaid”.

The nonwoven fabrics of Coform and “airlaid” types are in general characterized by weak strength and high susceptibility to pilling, and ready release of fibers, even on gentle rubbing. Moreover, processes of production of these materials generate micro-sized plastic particles, which are not biodegradable and can be detrimental to the environment.

There is also a generally known process, in which pulp fibers and short synthetic-bonding fibrils (regenerated cellulose, PET, PP, two-component fibers) are subjected to mixing in a stream of water, and a wet-formed layer in the wetlaid process is finally subjected to water needling and thermal drying, during which thermal activation of thermoplastic fibers is performed, when their thermal activation is necessary. This type of a nonwoven fabric material has numerous advantages and drawbacks, depending on the types of fibers used in a mixture with pulp and a final finish. Depending on the above, the nonwoven fabric can be biodegradable, if it contains biodegradable (primarily cellulose) fibers only. In the case of a nonwoven fabric formed exclusively from biodegradable fibers, it is characterized by weak strength. If its strength has to be enhanced, at least 40% of biodegradable synthetic short staple fibers should be used. Then higher strength of a nonwoven fabric is obtained, but at much higher costs, which makes the nonwoven fabric not cost-competitive relative to other existing biodegradable nonwoven fabric solutions.

In the case of using thermoplastic bonding fibers a cost of a nonwoven fabric is lower, the nonwoven fabric is more durable, but is no longer biodegradable, and a nonwoven fabric substrate, after use and partial degradation, becomes an emission source of micro-plastics to the environment.

The object of the invention is to provide a biodegradable nonwoven fabric, fully neutral to the natural environment and compostable in normal soil conditions, which is, at the same time, just as cost-effective and useful as traditionally used non-biodegradable nonwoven fabrics. The object is implemented by a method according to the invention.

### DISCLOSURE OF THE INVENTION

The invention provides a method of forming a layered biodegradable nonwoven fabric including a layer of cellulose pulp, containing at least 50% by weight of cellulose pulp based on dry weight of the nonwoven fabric, and a layer of carded fibers, wherein the layers are bonded by water needling, wherein the method comprises the following steps of:

(a) wet-forming any of the layers of the nonwoven fabric by dispersing cellulose pulp fibers in water, followed by straining out the pulp to obtain a layer of the cellulose pulp fibers,
(b) forming another layer in a method of carding fibers selected from the group consisting of viscose fibers, Lyocel (Tencel), cotton, cottonized flax, cottonized hemp fibers, or any mixture of at least two kinds of fibers selected from the group consisting of viscose fibers, Lyocel (Tencel), cotton, cottonized flax, cottonized hemp fibers, to obtain a layer of the carded fibers,
(c) applying the cellulose pulp fiber layer obtained in step (a) and the carded fiber layer obtained in step (b) in any order on each other and bonding with each other in a water needling process, followed by
(d) air-drying the nonwoven fabric obtained in step (c).

In the method according to the invention, the steps (a) and (b) can be performed in various order or simultaneously. Preferably, straining out the cellulose pulp fibers in step (a) of the method according to the invention is performed by means of a forming head. More preferably, the cellulose pulp used in step (a) is made from a softwood and/or scrap paper. Preferably, cotton used in step (b) is unbleached and/or regenerated cotton. Also preferably the needling method in step (c) is conducted with use of a water needling loom. Also preferably, a through-air dryer is used for drying the nonwoven fabric in step (d).

In a preferred embodiment, the cellulose pulp fibers used in step (a) are obtained from scrap paper. In this case the cellulose pulp fibers are purified from mechanical impurities on screens and/or from chemical impurities by means of a flotation process. The cellulose pulp purification step is carried out before the step of forming the cellulose pulp fiber layer.

Also preferably, viscose fibers, including the Lyocel (Tencel) fibers, are obtained from regenerated wood cellulose.

In one preferred embodiment, in step (b) of the method according to the invention, the layer of carded fibers is formed from unbleached cotton and/or regenerated cotton and/or cottonized flax and/or cottonized hemp. More preferably, in this embodiment, after the water needling step (step (c)), the nonwoven fabric is subjected to bleaching with bleaching substances selected from the group consisting of ozone, hydrogen peroxide, chlorine dioxide, or any combination thereof. Most preferably, in this embodiment, if required, the nonwoven fabric is treated with the pH adjusting agents and/or fiber softeners.

In an alternative embodiment, if the layer of carded fibers is formed of unbleached cotton and/or regenerated cotton and/or cottonized flax and/or cottonized hemp, the nonwoven fabric obtained in step (c) is reeled over a perforated tube and treated with bleaching substances selected from the group consisting of ozone, hydrogen peroxide and chlorine dioxide, and, if required, pH adjusting agents and fiber softeners. More preferably, in this embodiment, prior to drying by means of through-air dryer in step (d), the nonwoven fabric is unreeled from the perforated tube and subjected to a dewatering process. Preferably, in this embodiment, a method of purifying the nonwoven fabric (i.e. the step wherein the nonwoven fabric is subjected to bleaching substances) is carried out in a pressurized apparatus.

Preferably, a dry unit weight of the water-dispersed cellulose pulp fiber layer formed in step (a) is equal or greater than a unit weight of the carded fibers, form which the layer in step (b) is formed.

Preferably, the water-dispersed cellulose pulp fiber layer formed in step (a) is neither bonded nor compacted before contacting in step (c) with the carded fiber layer formed in step (b). Additionally preferably, the carded fiber layer formed in step (b) is neither bonded nor compacted before contacting in step (c) with the water-dispersed cellulose pulp fiber layer formed in step (a).

Preferably, the water-dispersed cellulose pulp fiber layer formed in step (a) comprises 85-100% by weight of bleached cellulose pulp fibers, admixed with 0-15% by weight of short staple fibers of regenerated cellulose or polylactide (PLA), or a mixture thereof, based on dry weight of the cellulose pulp fiber layer.

Preferably, the carded fiber layer formed in step (b) contains an additive of biodegradable bicomponent fibers, preferably containing PLA (polylactide), in the maximum amount of up to 10% by weight, based on dry weight of the carded fiber layer. Within the meaning of the present description, bicomponent fibers comprise a core and a shell made of two different materials or two different forms of materials characterized by different melting points. Preferably in the method according to the invention, bicomponent thermoplastic fibers are used, the shell and core of which are made of different PLA forms.

Preferably, the nonwoven fabric is dried in step (d) with air at the temperature sufficient to partially melt the shell of the biodegradable bicomponent fibers.

The invention provides also a biodegradable layered nonwoven fabric obtained by the method according to the invention. The nonwoven biodegradable fabric according to the invention is manufactured in at least 50% by weight from cellulose pulp based on dry weight of the nonwoven fabric, one of its layers comprising softwood and/or scrap paper cellulose pulp, and the second of the layers is a layer of carded fibers formed from fibers selected from the group consisting of viscose fibers, Lyocell (Tencel) fibers, cotton fibers, cottonized flax fibers and cottonized hemp fibers, or a mixture of at least two kinds of the above-mentioned fibers.

Preferably, a unit weight of any of the layers varies in the range between 10 g/m² and 60 g/m², more preferably in the range from 15 g/m² to 45 g/m².

Preferably, the cellulose pulp layer comprises from 85 to 100% by weight of softwood and/or scrap paper cellulose pulp and from 0 to 15% by weight of biodegradable bicomponent fibers, a component of which is PLA (polylactide), and more preferably from 90 to 93% by weight of softwood and/or scrap paper cellulose pulp and 7 to 10% by weight of biodegradable bicomponent fibers, a component of which is PLA (polylactide), based on dry weight of the cellulose pulp layer.

Preferably, the carded fiber layer comprises from 90 to 93% by weight of viscose fibers and/or Lyocel (Tencel) fibers and/or cotton and/or cottonized flax and/or cottonized hemp fibers, and 7 to 10% by weight of biodegradable bicomponent fibers, a component of which is PLA (polylactide), based on dry weight of the carded fiber layer.

The invention provides also a system of devices for forming a nonwoven biodegradable fabric, which in a processing line is provided with a pulper, a head forming a fiber layer from a water-dispersed cellulose pulp, a carding machine for forming a carded fiber layer, a needle loom for bonding fibers by means of kinetic energy of water micro-streams equipped with beams to form curtains of these micro-streams, a tank for water bath to oxidize impurities and bleach fibers, a through-air dryer and a reeling machine.

The nonwoven fabric manufactured by the method according to the invention does not constitute a source of plastic microparticle emission, which have a detrimental effect on the natural environment. Moreover, the process according to the invention contributes to reduction of costs of fibers used and to reduction of energy and chemical consumption in upstream processes, i.e. in the processes, in which the biodegradable fibers used in the nonwoven fabrics are manufactured.

An additional advantage of the nonwoven fabric according to the invention and the method for the manufacture thereof is a possibility to use in the manufacturing process the nonwoven fabric cellulose pulp reclaimed from scrap paper.

### BRIEF DESCRIPTION OF THE DRAWING

The object the invention was visualized in an embodiment in the attached figure of the drawing, wherein a scheme of a production line for the nonwoven fabric according to the invention is shown.

### DETAILED DESCRIPTION OF THE INVENTION

In the method of forming the biodegradable nonwoven fabric of the invention, which contains at least 50% by weight of cellulose pulp, based on dry weight of the nonwoven fabric and consists of two layers, wherein the first layer of the nonwoven fabric is obtained by dispersing cellulose pulp fibers in water, from which cellulose pulp fiber layer 7 is wet-formed, followed by straining out by means of a forming head 1, while the second layer is formed by means of a process of carding viscose fibers and/or Lyocell (Tencel) fibers and/or cotton and/or cottonized flax and/or cottonized hemp fibers, to obtain the carded fiber layer 8. Subsequently, both layers, the cellulose pulp fiber layer 7 and the carded fiber layer 8 are applied on each other in any order and bonded in a water needling process by means of the needle loom 3, followed by air-drying of the obtained nonwoven fabric by means of the through-air dryer 5. The final product in a form of a bilayered nonwoven fabric is preferably reeled into a roll on a reeling machine 6 and/or cut. It can also be treated differently depending on the desired form.

If the dispersed cellulose pulp fibers are obtained from scrap paper, they are purified from mechanical impurities on screens and purified from chemical impurities by a flotation process. The step of purifying cellulose pulp precedes the step of forming the cellulose pulp fiber layer. The viscose fibers, Lyocell (Tencel) are preferably obtained from regenerated wood cellulose. If the carded fiber layer is made of unbleached cotton and/or regenerated cotton and/or cottonized flax and/or cottonized hemp, the nonwoven fabric, following the water needling process, is treated with bleaching substances selected from substances such as ozone, hydrogen peroxide, chlorine dioxide, and, if required, pH adjusting agents and fiber softeners. In one embodiment the nonwoven fabric is purified in pressurized apparatuses, i.e. the process for the treatment of the nonwoven fabric with bleaching substances is carried out under the elevated pressure and/or elevated temperature. A dry unit weight of the water-dispersed cellulose pulp fiber layer is at least equal to a unit weight of the carded fibers. The water-dispersed cellulose pulp fiber layer is not bonded nor compacted before contacting the carded fiber layer, and the carded fiber layer is not bonded nor compacted before contacting the water-dispersed cellulose pulp fiber layer.

In another embodiment, if the carded fiber layer is made of unbleached cotton and/or regenerated cotton and/or cottonized flax and/or cottonized hemp, the obtained nonwoven fabric is reeled over a perforated tube and treated with bleaching substances selected from ozone, hydrogen peroxide and chlorine dioxide, and, if required, pH adjusting agents and fiber softeners. The process can be also conducted in a pressurized apparatus. The nonwoven fabric is unreeled from the perforated tube and dewatered, and air-dried in turn by means of a through-air dryer.

The nonwoven biodegradable fabric according to the invention, manufactured in at least 50% by weight of cellulose pulp, based on dry weight of the nonwoven fabric, comprises the first layer of softwood and/or scrap paper cellulose pulp, and the second layer comprising viscose fibers and/or Lyocell (Tencel) fibers and/or cotton and/or cottonized flax and/or cottonized hemp fibers. A unit weight of any of the layers is in the range between 10 g/m² and 60 g/m², and more preferably in the range from 15 g/m² to 45 g/m².

A system of devices for forming the nonwoven biodegradable fabric is provided in the processing line in a pulper 10, from which cellulose pulp is passed to a head 1 for forming a fiber layer 7 of water-dispersed cellulose pulp. Over the layer formed from the cellulose pulp fibers, a carded fiber layer 8, formed in a carding machine 2, is than applied. Both layers together are passed on a needle loom 3, where they are bonded by means of a curtain of water micro-streams generated from a needling beam 9. The bonded nonwoven fabric layers are introduced into a water bath in a tank 4, where oxidation of impurities and bleaching of the nonwoven fabric is performed. After washing, the nonwoven fabric from the tank 4 is passed to the through-air dryer 5, where it is dried. From the dryer, the finished nonwoven fabric is passed to the reeling machine 6, where it is reeled into a roll.

### EXAMPLE 1

A biodegradable composite nonwoven fabric is formed by assembling and water needling two layers described below. The first layer is formed in a process of carding 100% viscose (regenerated cellulose) fibers and has a basis weight of 17-20 g/m². The second layer composed of 100% of bleached softwood cellulose pulp fibers is wet-formed in a wetlaid process on a casting-straining headbox type machine and has a basis weight of 33-37 g/m². Both fiber layers are formed as non-bonded and non-compressed before their mutual contact. Over a fleece of the carded viscose fibers, the hydro-formed cellulose pulp fiber layer is applied, and the obtained bilayered structure is processed by water needling. The obtained nonwoven fabric is then dried, and subjected to further treatment by cutting and/or reeling. Depending on the required final form, the nonwoven fabric may be subjected to further treatment.

### EXAMPLE 2

A water-needled biodegradable composite nonwoven fabric was obtained in an analogous manner to the one described in Example 1. The first layer is formed in a process of carding 100% Tencel (Lyocell) (regenerated cellulose) fibers and has a basis weight of 16-21 g/m². The second layer composed of 100% of bleached softwood cellulose pulp fibers, is wet-formed in a wetlaid process on a casting-straining headbox type machine and has a basis weight of 32-38 g/m². Both fiber layers are formed as non-bonded and non-compressed before their mutual contact. Over a fleece of the carded Tencel fibers the hydro-formed bleached cellulose pulp fiber layer is applied, and the obtained bilayered structure is processed by water needling. The obtained nonwoven fabric is then dried, and subjected to further treatment by cutting and/or reeling. Depending on the required final form, the nonwoven fabric may be subjected to further treatment.

### EXAMPLE 3

A water-needled biodegradable composite nonwoven fabric was obtained in an analogous manner to the one described in examples above. The first layer is formed in a process of carding 100% of non-bleached cotton fibers and has a basis weight of 20-25 g/m². The second layer composed of 100% of cellulose pulp fibers obtained from scrap paper, is wet-formed in a wetlaid process on a casting-straining headbox type machine and has a basis weight of 25-35 g/m². Both fiber layers are formed as non-bonded and non-compressed before their mutual contact. Over a fleece of the carded cotton fibers the hydro-formed cellulose pulp fiber layer obtained from scrap paper is applied, and the obtained bilayered structure is successively subjected to a water needling and chemical purification process by means of bleaching oxidizers. In this example, samples were prepared using a hydrogen peroxide solution, ozone, chlorine dioxide as oxidizers in combination, with assistance of adjuvants, which improve the process. After chemical purification the nonwoven fabric is washed and dried. Then the obtained nonwoven fabric is cut and reeled. Depending on the required final form, the nonwoven fabric may be subjected to further treatment.

### EXAMPLE 4

A water-needled biodegradable composite nonwoven fabric was obtained in an analogous manner to the one described in examples above. The first layer is formed in a process of carding 100% of viscose (regenerated cellulose) fibers and has a basis weight of 17-20 g/m². The second layer composed of 93% by weight of bleached softwood cellulose pulp fibers and 7% by weight of short staple thermoplastic bicomponent fibers containing PLA (polylactide), based on dry weight of the second layer, is wet-formed in a wetlaid process on a casting-straining headbox type machine and has a basis weight of 33-37 g/m². Both fiber layers are formed as non-bonded and non-compressed before their mutual contact. Over a fleece of the carded viscose fibers a layer of hydro-formed combination of the cellulose pulp fibers and bicomponent thermoplastic fibers is applied, and the obtained bilayered structure is processed by water needling and dried at the sufficiently high temperature, to partly melt a meltable shell of bicomponent fibers, but not to damage a thermoplastic fiber core. Then the obtained nonwoven fabric is cut and reeled. Depending on the required final form, the nonwoven fabric may be subjected to further treatment.

### EXAMPLE 5

A water-needled biodegradable composite nonwoven fabric was obtained in an analogous manner to the one described in examples above. The first layer is formed in a process of carding 100% of bleached cotton fibers and has a basis weight of 22-25 g/m². The second layer composed of 100% of mechanically purified and chemically bleached cellulose pulp fibers, obtained from scrap paper, is wet-formed in a wetlaid process on a casting-straining headbox type machine and has a basis weight of 25-35 g/m². Both fiber layers are formed as non-bonded and non-compressed before their mutual contact. Over a fleece of the carded bleached cotton fibers the layer of hydro-formed cellulose pulp fibers is applied, and the obtained bilayered structure is processed by water needling. The obtained nonwoven fabric is then dried, an subjected to further treatment by cutting and/or reeling. Depending on the required final form, the nonwoven fabric may be subjected to further treatment.

### EXAMPLE 6

A water-needled biodegradable composite nonwoven fabric was obtained such as described in examples above. The first layer is formed in a process of carding 100% of cottonized hemp fibers and has a basis weight of of 25-35 g/m². The second layer, composed of 90% by weight of bleached softwood cellulose pulp fibers and 10% of short staple thermoplastic bicomponent fibers, one of components of which is PLA (Polylactide), based on dry weight of the second layer, is wet-formed in a wetlaid process on a casting-straining headbox type machine and has a basis weight of 35-45 g/m². Both fiber layers are formed as non-bonded and non-compressed before their mutual contact. Over a fleece of the carded cottonized hemp fibers a layer of hydro-formed combinations of the cellulose pulp fibers and bicomponent thermoplastic fibers is applied, and the obtained bilayered structure is processed by water needling and dried at the sufficiently high temperature, to partly melt a fusible shell of bicomponent fibers, but to not damage a thermoplastic fiber core. Then the obtained nonwoven fabric is cut and reeled. Depending on the required final form the nonwoven fabric may be subjected to further treatment.

### EXAMPLE 7

A water-needled biodegradable composite nonwoven fabric was obtained such as described in examples above. The first layer is formed in a process of carding 100% viscose (regenerated cellulose) fibers and has a basis weight of 17-25 g/m². The second layer composed of 90% by weight of bleached softwood cellulose pulp fibers and 10% by weight of short staple regenerated cellulose fibers—viscose fibers), based on dry weight of the second layer, is wet-formed in a wetlaid process on a casting-straining headbox type machine and has a basis weight of 33-37 g/m². Both fiber layers are formed as non-bonded and non-compressed before their mutual contact. Over a fleece of the carded viscose fibers a layer of a combination of the hydro-formed fibers of cellulose and viscose pulps, and the obtained bilayered structure is processed by water needling. The obtained nonwoven fabric is then dried an subjected to further treatment by cutting and/or reeling. Depending on the required final form the nonwoven fabric may be subjected to further treatment.

### EXAMPLE 8

Samples of the nonwoven fabrics obtained in Examples 1-7 were subjected to tests to verify their strength and pilling resistance.

All samples of the nonwoven fabric obtained in a process according to the invention exhibited suitable properties allowing their use in cosmetic applications and a household.

1. A method of forming a biodegradable nonwoven fabric containing at least 50% by weight of cellulose pulp based on dry weight of the nonwoven fabric consisting of two layers bonded by means of water needling, wherein in the said method the first layer of the nonwoven fabric is manufactured by dispersing cellulose pulp fibers in water, from which the cellulose pulp fiber layer is wet-formed, which layer is strained out, and the second layer is formed in a process of carding fibers selected from a group consisting of viscose fibers, Lyocell fibers, cotton fibers, cottonized flax fibers and cottonized hemp fibers, or any mixture thereof, to obtain the carded fiber layer, then both the cellulose pulp fiber layer and the carded fiber layer are applied onto each other in any order and are bonded in a water needling process by means of a needle loom, followed by air-drying of the obtained nonwoven fabric.

2. The method according to claim 1, wherein the wet-formed cellulose pulp fiber layer is strained out by means of a forming head.

3. The method according to claim 1, wherein the obtained nonwoven fabric is dried by means of the through-air dryer.

4. The method according to claim 1, wherein the first layer of the nonwoven fabric is manufactured from cellulose pulp obtained from scrap paper.

5. The method according to claim 4, which comprises an additional step of purifying the cellulose pulp obtained from scrap paper from mechanical impurities on screens.

6. The method according to claim 4, which comprises an additional step of purifying the cellulose pulp obtained from scrap paper form chemical impurities by a flotation process.

7. The method according to claim 1, wherein viscose fibers, including Lyocell fibers, used for forming the second layer, are obtained from regenerated wood cellulose.

8. The method according to claim 1, wherein the carded fiber layer is manufactured from unbleached cotton and/or regenerated cotton and/or cottonized flax and/or cottonized hemp, and the obtained nonwoven fabric after the water needling process is treated with bleaching substances selected from the group consisting of ozone, hydrogen peroxide, chlorine dioxide, or a mixture thereof, and optionally treated with pH adjusting agents and/or fiber softeners.

9. The method according to claim 1, wherein the carded fiber layer is manufactured from unbleached cotton and/or regenerated cotton and/or cottonized flax and/or cottonized hemp, and the obtained nonwoven fabric is reeled over a perforated tube and treated with bleaching substances selected from ozone, hydrogen peroxide and chlorine dioxide, or a mixture thereof, and optionally treated with pH adjusting agents and/or fiber softeners.

10. The method according to claim 9, wherein the nonwoven fabric a treated with bleaching substances in pressurized apparatuses.

11. The method according to claim 9, wherein the nonwoven fabric is unreeled from the perforated tube, dewatered, followed by air-drying by means of a through-air dryer.

12. The method according to claim 1, wherein the water-dispersed cellulose pulp fiber layer in the manufactured nonwoven fabric has a dry unit weight equal or greater than a unit weight of the carded fiber layer.

13. The method according to claim 1, wherein the water-dispersed cellulose pulp fiber layer is not bonded nor compressed before contacting with the carded fiber layer, and the carded fiber layer is not bonded nor compressed before contacting with the water-dispersed cellulose pulp fiber layer.

14. The method according to claim 1, wherein the water-dispersed cellulose pulp fiber layer is composed of 85-100% by weight of bleached cellulose pulp fibers, admixed with 0-15% by weight of short staple regenerated cellulose fibers, PLA, or a mixture thereof, based on dry weight of the cellulose pulp fiber layer.

15. The method according to claim 1, wherein the carded fiber layer contains an additive in a form of biodegradable bicomponent fibers in a maximum amount of up to 10% based on dry weight of the carded fiber layer.

16. The method according to claim 15, wherein the biodegradable bicomponent fibers in the carded fiber layer contain PLA.

17. The method according to claim 15, wherein the nonwoven fabric is dried with air at the temperature sufficient to partly melt the shell of the biodegradable bicomponent fibers contained in the carded fibers layer.

18. A nonwoven biodegradable fabric comprising two layers bonded by means of a water needling process, containing at least 50% by weight of cellulose pulp based on dry weight of the nonwoven fabric, comprising two layers, wherein the first one of its layers comprises a wet-formed softwood cellulose pulp and/or scrap paper fiber layer, and the second one of layers comprises a carded viscose fiber and/or Lyocell fibers and/or cotton and/or cottonized flax and/or cottonized hemp fiber layer.

19. The nonwoven fabric according to claim 18, wherein a unit weight of any of the layers is in the range between 10 g/m² and 60 g/m².

20. The nonwoven fabric according to claim 19, wherein a unit weight of any of the layers is in the range from 15 g/m² to 45 g/m².

21. The nonwoven fabric according to claim 18, wherein the wet- formed cellulose pulp fiber layer contains from 90 to 93% by weight of softwood and/or scrap paper cellulose pulp and from 7 to 10% by weight of biodegradable bicomponent fibers, a component of which is PLA, based on dry weight of the cellulose pulp fiber layer.

22. The nonwoven fabric according to claim 18, wherein the carded fiber layer contains from 90 to 93% by weight of viscose fibers and/or Lyocell fibers and/or cotton fibers and/or cottonized flax and/or cottonized hemp fibers and from 7 to 10% by weight of biodegradable bicomponent fibers, a component of which is PLA, based on dry weight of the carded fiber layer.

23. A system of devices for forming the biodegradable nonwoven fabric as defined in claim 17, which is provided in a processing line in a pulper, a head for forming a fiber layer of the water-dispersed cellulose pulp, a carding machine for forming a carded fiber layer, a needle loom for bonding fibers by means of kinetic energy of water micro- streams from the needling beam, forming curtains of the streams, tanks for the water bath for oxidizing impurities and bleaching fibers, the through-air dryer and the reeling machine.
